(19) United States
(12) Patent Application Publication
(10) Pub. No.: US 2018/0336820 A1
(43) Pub. Date: Nov. 22, 2018

(54) PIXEL DRIVING CIRCUIT, DISPLAY PANEL AND PIXEL DRIVING METHOD

(71) Applicant: SHENZHEN CHINA STAR OPTOELECTRONICS TECHNOLOGY CO., LTD., Shenzhen, Guangdong (CN)

(72) Inventor: Yuying CAI, Shenzhen, Guangdong (CN)

(73) Assignee: Shenzhen China Star Optoelectronics Technology Co., Ltd., Shenzhen, Guangdong (CN)

(21) Appl. No.: 15/544,000

(22) PCT Filed: May 31, 2017
(86) PCT No.: PCT/CN2017/086737

§ 371 Date: Jul. 15, 2017

(30) Foreign Application Priority Data
Apr. 28, 2017 (CN) 201710296115.3

(51) Int. Cl. G09G 3/3233

(52) U.S. Cl. CPC G09G 3/3233; G09G 2320/0233

(57) ABSTRACT

A pixel driving circuit is disclosed, including: a driving switch, connected between a driving power source and an OLED; a first switch, connected to the gate of the driving switch for inputting a first control signal; a control circuit, connected to the source of the driving switch, for inputting a second control signal and outputting a compensation current to compensate threshold voltage drift of the driving switch; a storage unit, connected between the gate and source of the driving switch, for storing a compensation voltage of compensation current compensating the driving switch; the drain of first switch being for inputting a data signal, the storage unit being for storing a data voltage generated by the data signal and applying the compensation voltage and data voltage to the driving switch. A display panel and pixel driving method are also disclosed.

### CROSS REFERENCE TO RELATED APPLICATIONS

This application claims the priority of Chinese Patent Application No. 2017102961153, entitled “Pixel Driving Circuit, Display Panel and Pixel Driving Method”, filed on Apr. 28, 2017, the disclosure of which is incorporated herein by reference in its entirety.

### BACKGROUND OF THE INVENTION

### 1. Field of the Invention

The present invention relates to the field of display, and in particular to the field of pixel driving circuit, display panel and pixel driving method.

### 2. The Related Arts

The current organic light-emitting diode (OLED) display has the advantages of small size, simple structure, active luminescence, high brightness, large viewing angle and short response time, and attracts a wide range of attention.

A conventional OLED display includes a transistor as a driving transistor for controlling the current through the OLED, so that the importance of the threshold voltage of the driving transistor is apparent. Any positive or negative drift of the threshold voltage will cause different currents flowing through the OLED under the same signal. At present, the transistor may experience threshold voltage drift during the use process because of, such as, lighting on oxide semiconductor, the voltage stress on the source and drain and other factors, which results in the current flowing through the OLED unstable, and thus causes the panel luminance not uniform.

### SUMMARY OF THE INVENTION

The primary object of the present invention is to provide a pixel driving circuit, display panel and pixel driving method, to solve the problem of threshold voltage drift causing unstable current in OLED in the known technology, to achieve uniform luminance for display panel.

To solve the aforementioned issues, the present invention provides a pixel driving circuit, comprising:

a driving switch, connected between a driving power source and an organic light-emitting diode (OLED);

a first switch, connected to a gate of the driving switch, for inputting a first control signal;

a control circuit, connected to a source of the driving switch, for inputting a second control signal and outputting a compensation current to compensate threshold voltage drift of the driving switch;

a storage unit, connected between a gate and a source of the driving switch, for storing a compensation voltage of the compensation current provided to the driving switch;

the first switch having a drain for inputting a data signal, the storage unit being for storing a data voltage generated by the data signal, and for applying the compensation voltage and the data voltage to the driving switch.

According to an embodiment of the present invention, the control circuit comprises:

a compensation current output end, for outputting the compensation current;

a second switch, connected between the compensation current output end and the source of the driving switch, and having a gate for inputting the second control signal, and being a thin film transistor (TFT) of the same model as the driving switch.

According to an embodiment of the present invention, the first switch and the second switch are N-type thin film transistors (TFT).

According to an embodiment of the present invention, the first switch and the second switch are P-type thin film transistors (TFT).

The present invention provides a display panel, comprising:

a pixel driving circuit; the pixel driving circuit comprising: a driving switch, connected between a driving power source and an organic light-emitting diode (OLED);

a first switch, connected to a gate of the driving switch, for inputting a first control signal;

a control circuit, connected to a source of the driving switch, for inputting a second control signal and outputting a compensation current to compensate threshold voltage drift of the driving switch;

a storage unit, connected between a gate and a source of the driving switch, for storing a compensation voltage of the compensation current provided to the driving switch;

the first switch having a drain for inputting a data signal, the storage unit being for storing a data voltage generated by the data signal, and for applying the compensation voltage and the data voltage to the driving switch.

According to an embodiment of the present invention, the control circuit comprises:

a compensation current output end, for outputting the compensation current;

a second switch, connected between the compensation current output end and the source of the driving switch, and having a gate for inputting the second control signal, and being a thin film transistor (TFT) of the same model as the driving switch.

According to an embodiment of the present invention, the first switch and the second switch are N-type TFTs.

According to an embodiment of the present invention, the first switch and the second switch are P-type TFTs.

The present invention also provides a pixel driving method, providing a pixel driving circuit, the pixel driving circuit comprising: a driving power source, an organic light-emitting diode (OLED), a driving switch, a first switch, a storage unit and a control circuit; the driving switch being connected between the driving power source and the OLED; the first switch being connected to a gate of the driving switch; the control circuit being connected to a source of the driving switch; the storage unit being connected between a gate and a source of the driving switch; the method comprising:

in a first time period, loading in a first control signal and a second control signal, conducting the first switch and the control circuit, the control circuit loading in a compensation current to compensate threshold voltage drift of the driving switch, and storing a compensation voltage in the storage unit;

in a second time period, loading in the first control signal and the second control signal, conducting the first switch and cutting off the control circuit, outputting a data signal to the storage unit, and the storage unit storing a data voltage generated by the data signal;

in the third time period, loading in the first control signal and the second control signal, cutting off the first switch and the control circuit, the storage unit applying the compensation voltage and the data voltage to a gate of the driving switch, the driving power source driving the OLED to emit light.

According to an embodiment of the present invention, the control circuit comprises:

a compensation current output end, for outputting the compensation current;

a second switch, connected between the compensation current output end and the source of the driving switch, and having a gate for inputting the second control signal, and being a thin film transistor (TFT) of the same model as the driving switch.

According to an embodiment of the present invention, the first switch and the second switch are N-type TFTs.

According to an embodiment of the present invention, the first switch and the second switch are P-type TFTs.

According to an embodiment of the present invention, a transitional time period is provided between the first time period and the second time period, and between the second time period and the third time period, for reserving time to propagate the first control signal, the second control signal, and the data signal.

The advantage of the present invention is as follows: in the first time period, the compensation current compensates the threshold voltage drift of the driving switch and stored in the storage unit in a form of compensation voltage; the storage unit stores the data voltage in the second time period and releases the compensation voltage and the data voltage in the third time period to control the driving voltage to drive the OLED to emit light. The compensation current and data signal are independently applied to the pixel driving circuit. Without affecting the data signal, the threshold voltage drift of the driving switch is compensated and the current through the OLED is stable, leading to uniform luminance of the display panel.

### BRIEF DESCRIPTION OF THE DRAWINGS

To make the technical solution of the embodiments according to the present invention, a brief description of the drawings that are necessary for the illustration of the embodiments will be given as follows. Apparently, the drawings described below show only example embodiments of the present invention and for those having ordinary skills in the art, other drawings may be easily obtained from these drawings without paying any creative effort.

FIG. 1 is a schematic view showing the circuitry of the pixel driving circuit of the present invention.

FIG. 2 is a schematic view showing the timing of the pixel driving method of the present invention.

FIG. 3 is a schematic view showing the circuit state in the first time period of the pixel driving method of the present invention.

FIG. 4 is a schematic view showing the circuit state in the second time period of the pixel driving method of the present invention.

FIG. 5 is a schematic view showing the circuit state in the third time period of the pixel driving method of the present invention.

### DETAILED DESCRIPTION OF THE PREFERRED EMBODIMENTS

To further explain the technical means and effect of the present invention, the following refers to embodiments and drawings for detailed description. Apparently, the described embodiments are merely some embodiments of the present invention, instead of all embodiments. All other embodiments based on embodiments in the present invention and obtained by those skilled in the art without departing from the creative work of the present invention are within the scope of the present invention.

The pixel driving circuit of the present invention is applicable to OLED display, for providing stable current to the OLED to drive the OLED to emit light with uniform luminance. The OLED has the advantages of energy-saving, fast response, light weight, thinness, simple structure, and low cost, and is widely used in display devices.

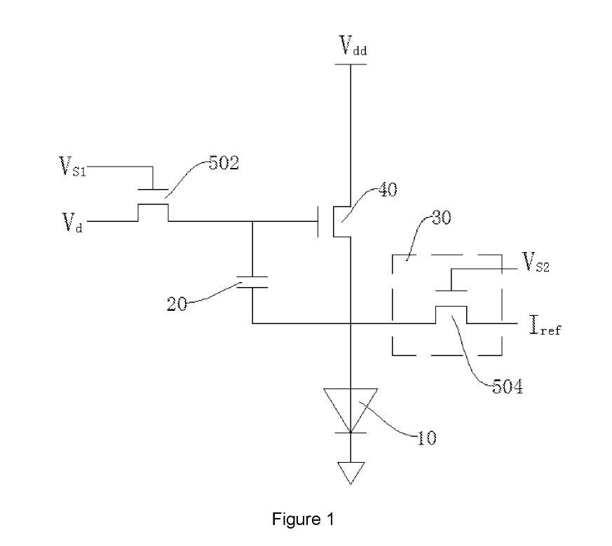

Refer to FIG. 1. The pixel driving circuit of the present invention comprises: a driving power source, an organic light-emitting diode (OLED) 10, a driving switch 40, a first switch 502, a storage unit 20 and a control circuit 30. Specifically, the driving switch 40 is connected between the driving power source and the OLED 10; and the driving power source is for driving the OLED 10 to emit light as well as driving other electronic elements of the display device. In the present embodiment, the driving switch 40 is a thin film transistor (TFT), which is a type of field effect transistor (FET), having a gate, a drain and a source. Moreover, the TFT comprises N-type TFT and P-type TFT. Take the N-type TFT as example. When the voltage difference V_{gs} between the gate and the source is greater than the threshold voltage Vₜₕ, the drain and the source are conductive, and the current flows from the drain to the source, i.e., the current flows through the driving switch 40 to drive the OLED 10 to emit light. Therefore, controlling the voltage difference V_{gs} between the gate and the source of the driving switch 40 is able to control the conduction or cut-off of the driving switch 40. Moreover, according to the equation:

I_{ds}=K(V_{gs}−Vₜₕ)² (1)

Wherein, K=μCoxW/(2L), and μ is the carrier migration rate of the driving switch 40, W and L are the width and length of the driving switch 40 respectively.

The current I_{ds} flowing through the driving switch 40 to drive the OLED 10 depends on the voltage difference V_{gs} between the gate and the source and the threshold voltage Vₜₕ. When the threshold voltage Vₜₕ of the driving switch 40 drifts, the compensation to the threshold voltage Vₜₕ drift of the driving switch 40 must be performed through the voltage difference V_{gs} between the gate and the source.

The first switch 502 has a gate connected to the storage unit 20, a drain connected to a data line, and a gate connected to a first scan line. The first scan line outputs a first control signal Vₛ₁ to the gate, the data line outputs a data signal V_{d} to the first switch 502 and stores the data signal V_{d} in a form of data voltage V_{data} in the storage unit 20 for subsequent outputting to the driving switch 40 to control the PLED 10 to emit light.

The control circuit 30 is connected to a source of the driving switch 40, for inputting a first control signal Vₛ₁ and outputting a compensation current I_{ref} to compensate threshold voltage Vₜₕ drift of the driving switch 40. Specifically, the first control signal Vₛ₁ controls conduction and cut-off of the control circuit 30, so as to control whether the compensation current I_{ref} can flow to the driving switch 40. In the present embodiment, the first control signal Vₛ₁ is provided by a first scan line of the display panel.

Specifically, the control circuit 30 comprises: a compensation current output end and a second switch 504. The compensation current output end is for outputting the compensation current I_{ref}; the compensation current I_{ref} flows passing the second switch 504 and to the OLED 10. Furthermore, the second switch 504 and the driving switch 40 are TFTs of the same model; that is, the second switch 504 and the driving switch 40 have the same carrier migration rate μ, channel width W and channel length L, so that the second switch 504 and the driving switch 40 have the same threshold voltage Vₜₕ drift. In other embodiments, the control circuit 30 may also comprise a connected assembly of a plurality of TFTs, and each TFT has the same threshold voltage Vₜₕ drift as the driving switch 40. In combination with the connections of the second switch 504 and the driving switch 40, the compensation current I_{ref} flows, after passing the second switch 504, to the OLED 10; therefore, compensating the threshold voltage Vₜₕ drift of the second switch 504 is equal to compensating the threshold voltage Vₜₕ drift of the driving switch 40.

The second switch 504 has a gate inputting the second control signal Vₛ₂. The second control signal Vₛ₂ controls the second switch 504 to be conductive, the compensation current I_{ref} compensates the threshold voltage Vₜₕ drift of the second switch 504 and is stored in a form of compensation voltage in the storage unit 20 for, in the third time period (light-emitting phase), compensating the threshold voltage Vₜₕ drift of the driving switch 40.

The storage unit 20 is connected between a gate and a source of the second switch 504, for storing charge and releasing charge. The storage unit 20 stores different voltages at different time periods. Specifically, in the first time period, the storage unit 20 stores a compensation voltage of the compensation current I_{ref} provided to the second switch 504; in the second time period, the storage unit 20 stores a data voltage V_{data}; in the third time period, the storage unit 20 releases both the compensation voltage and the data voltage V_{data}. In a preferred embodiment, the storage unit 20 is a capacitor; in other embodiments, the storage unit 20 can also be electronic elements with storage function.

In the first time period, the compensation current I_{ref} compensates the threshold voltage Vₜₕ drift of the driving switch 40, and is stored in a form of compensation voltage in the storage unit 20. In the second time period, the storage unit 20 stores the data voltage V_{data}, and in the third time period, releases both the compensation voltage and the data voltage V_{data} to control the driving voltage V_{dd} to drive the OLED 10 to emit light. The compensation current I_{ref} and the data signal V_{d} are independently applied to the pixel driving circuit. Without affecting the data signal, the threshold voltage Vₜₕ drift of the driving switch 40 is compensated and the current through the OLED 10 is stable, leading to uniform luminance of the display panel.

In an embodiment, the first switch 502 and the second switch 504 are N-type TFTs In other embodiments, the first switch 502 and the second switch 504 are P-type TFTs.

In the first time period, the compensation current I_{ref} compensates the threshold voltage Vₜₕ drift of the driving switch 40, and is stored in a form of compensation voltage in the storage unit 20. In the second time period, the storage unit 20 stores the data voltage V_{data}, and in the third time period, releases both the compensation voltage and the data voltage V_{data} to control the driving voltage V_{dd} to drive the OLED 10 to emit light. The compensation current I_{ref} and the data signal V_{d} are independently applied to the pixel driving circuit. Without affecting the data signal, the threshold voltage Vₜₕ drift of the driving switch 40 is compensated and the current through the OLED 10 is stable, leading to uniform luminance of the display panel.

The present invention also provides a display panel comprising the aforementioned pixel driving circuit.

The present invention also provides a pixel driving method, to be realized through the pixel driving circuit provided by the present invention. Specifically, the pixel driving circuit comprises: a driving power source, an OLED 10, a driving switch 40, a first switch 502, a storage unit 20 and a control circuit 30; the driving switch 40 being connected between the driving power source and the OLED 10; the first switch 502 being connected to a gate of the driving switch 40; the control circuit 30 being connected to a source of the driving switch 40; the storage unit 20 being connected between a gate and a source of the driving switch 40.

Furthermore, the control circuit 30 comprises: a compensation current output end and a second switch 504. The compensation current output end is for outputting the compensation current I_{ref}; the compensation current I_{ref} flows passing the second switch 504 and to the OLED 10. Preferably, the second switch 504 and the driving switch 40 are TFTs of the same model; that is, the second switch 504 and the driving switch 40 have the same carrier migration rate μ, channel width W and channel length L, so that the second switch 504 and the driving switch 40 have the same threshold voltage Vₜₕ drift.

In the present embodiment, the driving switch 40, the first switch 502 and the second switch 504 are N-type TFTs.

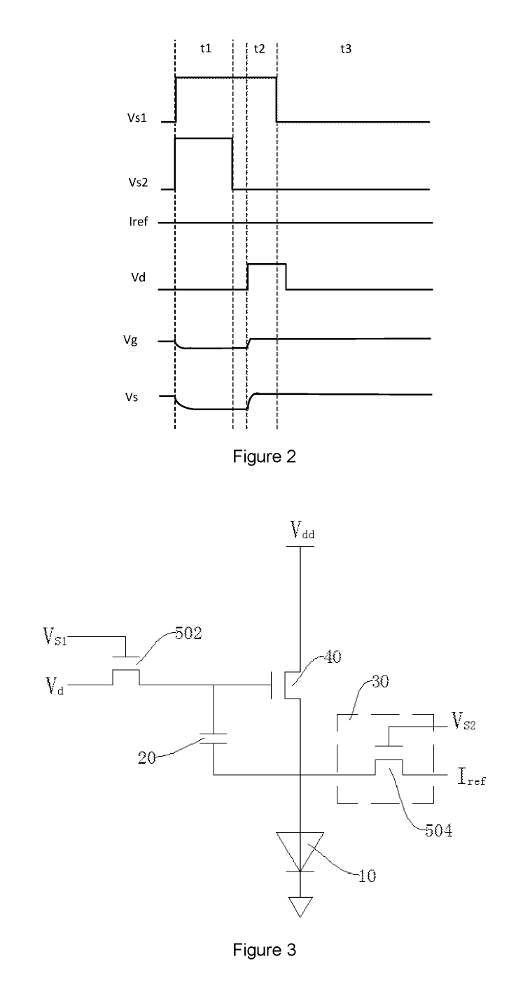

In combination of FIG. 2, the pixel driving method of the present invention comprises the following steps:

S101: in a first time period t1, in combination of FIG. 3, loading in a first control signal Vₛ₁ and a second control signal Vₛ₂, wherein the first control signal Vₛ₁ and the second control signal Vₛ₂ are both at high voltage so as to make the first switch 502 and the second switch 504 conductive. The control circuit 30 loads in a compensation current I_{ref}; and compensation current I_{ref} flows through the second switch 504 to the OLED 10, i.e., I_{ds}=I_{ref}, to compensate threshold voltage Vₜₕ drift of the driving switch 40, and stores a compensation voltage in the storage unit 20.

In the present embodiment, when the second switch is conductive, the compensation current I_{ref} flowing through the second switch 504 compensates threshold voltage Vₜₕ drift of the second switch 504 i.e., compensating threshold voltage Vₜₕ drift of the driving switch 40. Therefore, the current compensating the driving switch 40 is the compensation current I_{ref}. According to equation (1), the voltage difference between the gate and the source of the driving switch 40 is:

V_{gs}=(I_{ds}/K)^{1/2}+Vₜₕ

Furthermore, because

V_{gs}=V_{g}−Vₛ

Thus, Vₛ=V_{g}−(I_{ds}/K)^{1/2}−Vₜₕ

Wherein, V_{g} is the potential of the gate of the driving switch 40, and Vₛ is the potential of the source of the driving switch 40.

Furthermore, assume that the storage unit 20 comprises a first connection end A and a second connection end B. The first connection end A has a potential V_{A} equal to the potential of the gate V_{g} of the driving switch 40; and, the potential of the gate of the driving switch 40 is a reference voltage passing through the first switch 502; that is,

V_{A}=V_{g}=V_{ref}

The second connection end B has a potential V_{B} being a reference voltage V_{ref} passing through the second switch 504. That is,

V_{B}=Vₛ=V_{ref}−(I_{ds}/K)^{1/2}−Vₜₕ

The reference V_{ref} is a reference value, for subsequent comparison with data voltage V_{data}.

Therefore, in the first time period t1, the potentials at the two ends of the storage unit 20 are V_{A}=V_{ref} and V_{B}=V_{ref}−(I_{ds}/K)^{1/2}−Vₜₕ respectively. The compensation current I_{ref} compensating the threshold voltage Vₜₕ drift of the second switch 504 is stored in a compensation voltage in the storage unit 20. Because the second switch 504 and the driving switch 40 are transistors of the same model, in subsequent third time period (light-emitting phase), the compensation to the second switch 504 is equivalent to the compensation to the driving switch 40.

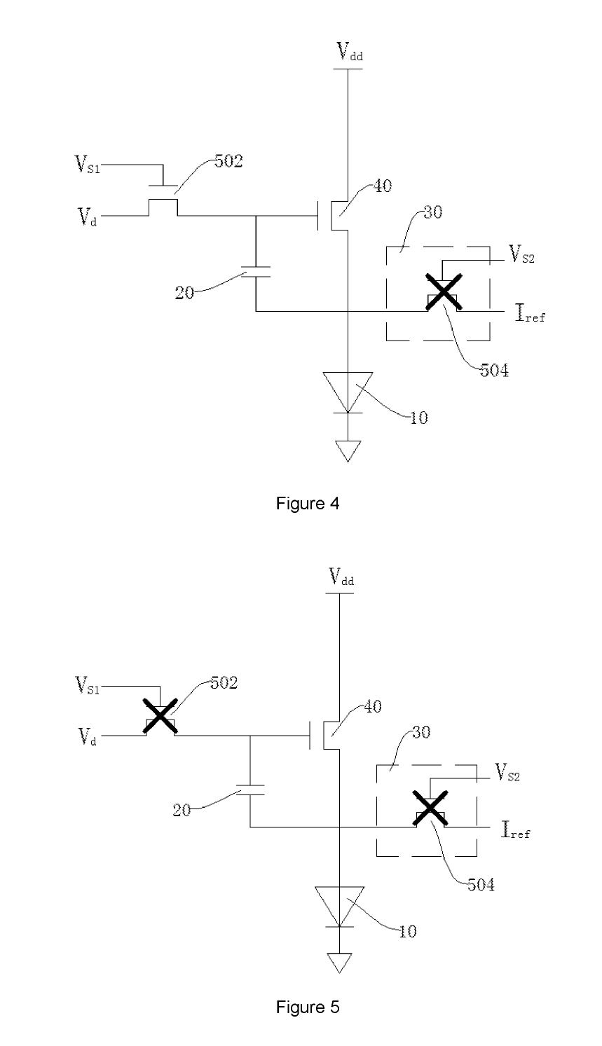

S102: in a second time period t2, in combination with FIG. 4, loading in the first control signal Vₛ₁ and the second control signal Vₛ₂, wherein the first control signal Vₛ₁ is high voltage and the second control signal Vₛ₂ is low voltage so that the first switch 502 is conductive and the second switch 504 is cut off. The data line outputs the data signal V_{d} through the first switch 502 to the storage unit 20, and stores in the form of V_{data} in the storage unit 20. In the mean time, the first connection end A of the storage unit 20 has the potential V_{A}=V_{d}=V_{data}, because the potentials at the two ends of the storage unit 20 cannot independently change suddenly, the potential V_{B} of the second connection end B of the storage unit also changed by the same amount. Specifically, the amount of change in potential is V_{data}−V_{ref}, therefore, the potential of the second connection end B of the storage unit 20:

V_{B}=V_{ref}−(I_{ds}/K)^{1/2}−Vₜₕ+V_{data}

Accordingly, in the second time period t2, the potentials of the two ends of the storage unit 20 are V_{A}=V_{data} and V_{B}=V_{ref}−(I_{ds}/K)^{1/2}−Vₜₕ+V_{data}−V_{ref}, respectively; the storage unit 20 stores the data voltage V_{data} for subsequent third time period (light-emitting phase) to control the driving switch 40 to make OLED 10 emit light.

In the third time period t3, in combination with FIG. 5, loading in the first control signal Vₛ₁ and the second control signal Vₛ₂, wherein the first control signal Vₛ₁ and the second control signal Vₛ₂ are both low voltages, and the first switch 502 and the second switch 504 are both cut off. The storage unit 20 applies the compensation voltage and the data voltage V_{data} to the gate of the driving switch 40, and the driving power source drives the OLED 10 to emit light. Specifically, the storage unit 20 discharges, and the potential V_{A} of the second connection end B of the storage unit V_{B}=V_{ref}−(I_{ds}/K)^{1/2}−Vₜₕ+V_{data}−V_{ref}, comprising the compensation voltage for compensating the threshold voltage Vₜₕ drift of the driving switch 40 in the first time period t1 and the data voltage V_{data} of the data signal V_{d} provided by the data line. As such, the current flowing through the OLED 10 is stable and the luminance for the display panel is uniform.

In the first time period t1, the compensation current I_{ref} compensates the threshold voltage Vₜₕ drift of the first switch 502, and is stored in a form of compensation voltage in the storage unit 20. In the second time period t2, the storage unit 20 stores the data voltage V_{data}, and in the third time period t3, releases both the compensation voltage and the data voltage V_{data} to control the driving voltage V_{dd} to drive the OLED 10 to emit light. The compensation current I_{ref} and the data signal V_{d} are independently applied to the pixel driving circuit. Without affecting the data signal, the threshold voltage Vₜₕ drift of the driving switch 40 is compensated and the current through the OLED 10 is stable, leading to uniform luminance of the display panel.

In another embodiment, the first switch 502 and the second switch 504 are N-type TFTs. In other embodiments, the first switch 502 and the second switch 504 are P-type TFTs.

In a preferred embodiment, a transitional time period is provided between the first time period t1 and the second time period t2, and between the second time period t2 and the third time period t3, for reserving time to propagate the first control signal Vₛ₁, the second control signal Vₛ₂, and the data signal V_{d}.

In the first time period t1, the compensation current I_{ref} compensates the threshold voltage Vₜₕ drift of the first switch 502, and is stored in a form of compensation voltage in the storage unit 20. In the second time period t2, the storage unit 20 stores the data voltage V_{data}, and in the third time period t3, releases both the compensation voltage and the data voltage V_{data} to control the driving voltage V_{dd} to drive the OLED 10 to emit light. The compensation current I_{ref} and the data signal V_{d} are independently applied to the pixel driving circuit. Without affecting the data signal, the threshold voltage Vₜₕ drift of the driving switch 40 is compensated and the current through the OLED 10 is stable, leading to uniform luminance of the display panel.

Embodiments of the present invention have been described, but not intending to impose any unduly constraint to the appended claims. Any modification of equivalent structure or equivalent process made according to the disclosure and drawings of the present invention, or any application thereof, directly or indirectly, to other related fields of technique, is considered encompassed in the scope of protection defined by the claims of the present invention.

What is claimed is:

1. A pixel driving circuit, comprising:
a driving switch, connected between a driving power source and an organic light-emitting diode (OLED);
a first switch, connected to a gate of the driving switch, for inputting a first control signal;
a control circuit, connected to a source of the driving switch, for inputting a second control signal and outputting a compensation current to compensate threshold voltage drift of the driving switch;
a storage unit, connected between a gate and a source of the driving switch, for storing a compensation voltage of the compensation current provided to the driving switch;
the first switch having a drain for inputting a data signal, the storage unit being for storing a data voltage generated by the data signal, and for applying the compensation voltage and the data voltage to the driving switch.

2. The pixel driving circuit as claimed in claim 1, wherein the control circuit comprises:
a compensation current output end, for outputting the compensation current;
a second switch, connected between the compensation current output end and the source of the driving switch, and having a gate for inputting the second control signal; and the second switch and the driving switch being thin film transistors (TFT) of the same model.

3. The pixel driving circuit as claimed in claim 2, wherein the first switch and the second switch are N-type thin film transistors (TFT).

4. The pixel driving circuit as claimed in claim 2, wherein the first switch and the second switch are P-type thin film transistors (TFT).

5. A display panel, comprising a pixel driving circuit, and the pixel driving circuit comprising:
a a driving switch, connected between a driving power source and an organic light-emitting diode (OLED);
a first switch, connected to a gate of the driving switch, for inputting a first control signal;
a control circuit, connected to a source of the driving switch, for inputting a second control signal and outputting a compensation current to compensate threshold voltage drift of the driving switch;
a storage unit, connected between a gate and a source of the driving switch, for storing a compensation voltage of the compensation current provided to the driving switch;
the first switch having a drain for inputting a data signal, the storage unit being for storing a data voltage generated by the data signal, and for applying the compensation voltage and the data voltage to the driving switch.

6. The display panel as claimed in claim 5, wherein the control circuit comprises:
a compensation current output end, for outputting the compensation current;
a second switch, connected between the compensation current output end and the source of the driving switch, and having a gate for inputting the second control signal; and the second switch and the driving switch being thin film transistors (TFT) of the same model.

7. The display panel as claimed in claim 6, wherein the first switch and the second switch are N-type thin film transistors (TFT).

8. The display panel as claimed in claim 6, wherein the first switch and the second switch are P-type thin film transistors (TFT).

9. A pixel driving method, providing a pixel driving circuit, the pixel driving circuit comprising: a driving power source, an organic light-emitting diode (OLED), a driving switch, a first switch, a storage unit and a control circuit; the driving switch being connected between the driving power source and the OLED; the first switch being connected to a gate of the driving switch; the control circuit being connected to a source of the driving switch; the storage unit being connected between a gate and a source of the driving switch; the method comprising:
in a first time period, loading in a first control signal and a second control signal, conducting the first switch and the control circuit, the control circuit loading in a compensation current to compensate threshold voltage drift of the driving switch, and storing a compensation voltage in the storage unit;
in a second time period, loading in the first control signal and the second control signal, conducting the first switch and cutting off the control circuit, outputting a data signal to the storage unit, and the storage unit storing a data voltage generated by the data signal;
in the third time period, loading in the first control signal and the second control signal, cutting off the first switch and the control circuit, the storage unit applying the compensation voltage and the data voltage to a gate of the driving switch, the driving power source driving the OLED to emit light.

10. The pixel driving method as claimed in claim 9, wherein the control circuit comprises:
a compensation current output end, for outputting the compensation current;
a second switch, connected between the compensation current output end and the source of the driving switch, and having a gate for inputting the second control signal; and the second switch and the driving switch being thin film transistors (TFT) of the same model.

11. The pixel driving method as claimed in claim 10, wherein the first switch and the second switch are N-type thin film transistors (TFT).

12. The pixel driving method as claimed in claim 10, wherein the first switch and the second switch are P-type thin film transistors (TFT).

13. The pixel driving method as claimed in claim 9, wherein a transitional time period is provided between the first time period and the second time period, and between the second time period and the third time period, for reserving time to propagate the first control signal, the second control signal, and the data signal.
